(19) United States
(12) Patent Application Publication
(10) Pub. No.: US 2019/0251384 A1
(43) Pub. Date: Aug. 15, 2019

(54) METHOD FOR IDENTIFYING AN OBJECT AND PROVIDING INFORMATION

(71) Applicant: TKR Spezialwerkzeuge GmbH, Gevelsberg (DE)

(72) Inventor: Torsten Kreischer, Wetter (DE)

(21) Appl. No.: 16/274,382

(22) Filed: Feb. 13, 2019

(30) Foreign Application Priority Data
Feb. 15, 2018 (DE) 10 2018 103 449.0

(51) Int. Cl. G06K 9/32; G06K 9/00; G06T 7/90; H04W 4/02

(52) U.S. Cl. CPC G06K 9/3241; H04W 4/026; G06T 7/90; G06K 9/00671

(57) ABSTRACT

A method for identifying an object and providing information concerning the identified object on a mobile hand-held device. A camera unit for creating an electronic image of the object to be identified, a transmitter and receiver unit for the wireless data transmission of information to a server unit, and a display unit for the data representation of information are provided. The method includes creating an electronic image of the object to be identified with the camera unit, transmitting the electronic image to an analysis unit of the server unit and identifying the object in the server unit by comparing the image transmitted with images of objects to be identified stored in a database, providing and transmitting information on the identified object stored in the database to the hand-held device, and representing the information on the display unit.

In workshops, particularly in automotive workshops, it is often necessary for repairing the defective systems, equipment, devices, or similar items of the vehicles in automotive workshops to replace defective components with new components. If there are problems with the electrical system, particularly the vehicle electrical system, there is often the need to replace defective plug connections with new ones once a specific fault detection and, if applicable, fault elimination on the defective component would be economically unviable due to its complexity. Thus, defective plugs or sockets, for example, are simply replaced.

The difficulty here with replacing defective components, particularly defective plugs and sockets, consists in the fact that, due to the plurality of different vehicles and vehicle variants, a plurality of different plugs and sockets are in use. This variety causes a major challenge for the identification of the object that has been identified as defective, seeing as the objects, particularly plugs and sockets, will often differ only slightly, i.e., in only a few characteristics, from one another. Even for a person skilled in the art, the selection of the proper spare part thus represents a major challenge, which is burdened with high error rates. An incorrect selection of the component to be replaced will then result in prolonged downtimes and increased costs.

Based on this, it is the object of the invention to provide a method and a system for identifying an object and providing information on said identified object on a mobile hand-held device.

The invention solves the object by a method with the features of claim 1 and a system with the features of claim 10. Advantageous further embodiments of the method and the system are indicated in the respective dependent claims.

For the method for identifying the object to be identified and for providing the corresponding information on said object, a mobile hand-held device is essential, which comprises
a camera unit for creating an electronic image of the object to be identified,
a transmitter and receiver unit for wireless data transmission of information to a server unit, and
a display unit for the data representation of information,
   wherein the following method steps:
creating an electronic image of the object to be identified using the camera unit of the mobile hand-held device,
transmitting the electronic image to an analysis unit of the server unit and identifying the object in the server unit by comparing the image transmitted with images of objects to be identified stored in a database, and
providing and transmitting information stored in the database on the object to be identified from the server unit to the hand-held device, and
representing the information on the display unit of the mobile hand-held device are performed.

The method according to the invention is characterized in that it enables a simple and reliable identification of objects using a mobile hand-held device. Particularly where the method is used within the domain of repair shops, particularly automotive repair shops, this method may be used to facilitate the identification of the component to be replaced for the workshop employee in a simple, convenient, and reliable manner. After the electronic image is created by the workshop employee with the camera unit of the mobile hand-held device, it is transmitted to the server unit via the transmitter/receiver unit. Then, an analysis unit performs a comparison of the electronic image within the server unit with images stored in a database of the server unit, wherein the data on a matching object stored in the database are, in turn, transmitted from the server unit to the mobile hand-held device. The information stored in the database on the identified object is then displayed on the display unit, typically an electronic display screen, of said device. Here, the wireless data transmission is performed e.g. via a mobile communications network or a WLAN connection within the repair shop.

The workshop employee is then able to pick the corresponding spare part from a possibly existing warehouse, or to order it. Particularly advantageously, ordering options may also be displayed in addition to the information already given on the display unit, wherein the workshop employee, particularly advantageously, has the option to order the desired spare part directly on the display unit, for example via an “online shop”. Thus, the workshop employee is enabled in a particularly convenient manner to identify a defective component and even order said component if needed, so that a replacement of the defective component may take place within a minimum amount of time.

The cross-linking of the database to a central server unit offers the option of always being able to provide the user with up-to-date information by centrally updating the cross-linked data. Thus, in contrast to the case of an identification taking place only locally on the mobile hand-held device, it is not necessary to regularly update the information then stored on the hand-held device.

The creation of the electronic image of the object to be identified may in principle be performed in any manner desired, wherein the user points the hand-held device with the camera unit facing the object to be identified. According to a particularly advantageous embodiment of the invention, it is, however, provided that the creation of the electronic image is performed in a manner shown on the display unit.

According to this further embodiment of the invention, it is possible to show a viewfinder, for example, on the display unit of the mobile hand-held device, on which the object captured by the camera unit is represented as a real-time image. By superimposing e.g. frame lines or grid lines on the display unit when the image is created, the user is supplied with an aid for creating the electronic image of the object to be identified on a scale corresponding with the scale of the images stored in the database. The display unit may further be used to support the user in creating multiple images of the object to be identified. Accordingly, the user may be instructed through the appropriate instructions and appropriate frame lines, for example, to create additional views that are used for identifying the object. Accordingly, e.g. a top view, a side view, and a front view may be created when the electronic image is created by the user, which enable a particularly reliable identification by the analysis unit. The items superimposed on the display unit when the electronic image is being created represent an assistance system.

According to a particularly advantageous embodiment of the invention, it is further provided that, during the creation of the electronic image, the camera unit is shifted, particularly privoted, with respect to the object to be identified in a manner specified on the display unit.

In this advantageously provided procedure for creating the electronic image, the camera unit is moved with respect to the object to be identified during the capturing of the image, wherein the object is captured from multiple angles during the movement process. The movement direction of the camera unit with respect to the object to be identified is displayed for the user on the display unit so that a standardized image is created, similarly to a video recording, of the object to be identified, which makes it possible to identify the object in a particularly simple and reliable manner using the analysis unit. Alternatively to creating a video, supplemental images may also be created during the movement process in an automated manner depending on the movement, orientation, and position of the mobile hand-held device, which, as a whole, represent an electronic image of the object to be identified on which the comparison performed in the analysis unit is based.

According to a further embodiment of the invention, it is provided that, prior to the transmission to the analysis unit or in the analysis unit, the electronic image is electronically processed, particularly adjusted with respect to the brightness and the image size, in such a way that it will match the images stored in the database, particularly with respect to the image size and brightness of the images stored in the database.

According to this further embodiment of the invention, the electronic images created by the user are electronically processed already prior to their transmission to the analysis unit or in the analysis unit. Image files may for example be brightened or enlarged by suitable processing algorithms through which the electronic images of the object to be identified are adjusted to the format of the images stored in the database, so that a particularly reliable comparison may be performed. Electronic processing in which contrast values or sharpness, for example, can also be adjusted will additionally increase recognition accuracy.

The configuration of the identification performed in the analysis unit may in principle be performed in any manner, wherein various methods may be used for object recognition. According to a particularly advantageous confirmation of the invention, it is, however, provided that the shape type and/or at least one object characterization of a characterizing part disposed on the object to be identified are determined when the image is electronically processed using automatic pattern recognition.

In the case of the use of the method for identifying plugs in the automotive domain provided as an example, the shape type represents the outer shape of the plug. When the geometrical shape of the plug or the socket is determined, its width, length, and height, as well as the shape of steps, if applicable, may be determined, for example. The object features determined can then be compared with the object features of the objects stored in the database. Additionally or alternatively to the pattern recognition using the shape type of the object, the further developed method provides that an object characterization of the object to be identified is determined during the electronic image processing. An object characterization here may be defined features of the object to be identified that are independent from the shape, e.g. special markings, embossings, and the color scheme configuration, but also labels or similar items arranged on the surface.

Particularly where the shape type and the object characterization are captured in combination, the identification of the object to be identified may be performed in a particularly reliable and fast manner within the confines of the analysis unit by comparing them with the objects stored in the database, according to which a fault detection can be narrowed down using an increasing number of matching features.

According to a particularly advantageous embodiment of the invention, it is provided that, for identifying objects in the form of plug housings, the contact pins located on the plug housing and/or the shape of a coupling portion of the plug housing form the object characterization. In particular, the use of the number, orientation, and arrangement of the contact pins of a plug housing or the contact pin receptacles in a socket allows for a particularly reliable identification of the object to be identified.

The use of the contact pins or contact pin receptacles for identification here is characterized particularly in that the object characterization defined by them manifests very differently between individual plugs or individual sockets and is thus particularly well suited as an identifying feature. Accordingly, plugs/sockets with a multi-row arrangement of the contact pins/contact pin receptacles in particular form special patterns defined by them. The typically metal configuration of the contact pins or contact pin receptacles further results in good reflection behavior, which facilitates a capturing of the arrangement of the contact pins or contact pin receptacles when the electronic image is being created. Further, contaminations that reduce the reflection behavior are not anticipated, as the contact pins and contact pin receptacles are protected from external influences when the plugs and sockets are in a connected state.

The use of the contact pins or contact pin receptacles for identifying the objects to be identified is thus particularly characterized in that said objects are exposed to almost no contamination during an operation where a plug connection is established, so that, after disconnecting the plug connection, this object characterization will not have any contamination, and thus a good identification of this object characterization can be achieved. An intervention by the user for cleaning of the object to be identified, particularly of the plug, is therefore not necessary.

The shape of the coupling portion serves as an alternative or additional feature for increasing the identification options, said coupling portion being typically configured individually and, in doing so, has e.g. specially arranged grooves or latch markers for the plug connection.

According to another embodiment of the invention, it is furthermore provided that the object characterization is formed by an encoding arranged on the object. An encoding may, in addition to a two-dimensional code such as a bar code or a QR code, also be a three-dimensional code which has protruding elevations, for example in the shape of dots or bars, and which are particularly advantageously provided with reflective coatings, so that a particularly reliable recognition of this object characterization may be achieved within the scope of creating the electronic image. The use of an encoding arranged on the object thus ensures an identification of the object in a reliable manner. Using the encoding in a supplemental manner thereby increases the rate and speed of identification in a supplemental manner.

According to another embodiment of the invention, it is furthermore provided that the object to be identified is illuminated with an illumination unit arranged on the hand-held device while the electronic image is being created. The use of an illumination unit increases the quality of the electronic images created and thereby the quality and reliability of the identification method conducted. With the illumination unit, uniform illumination of the object to be identified is ensured while the image is being created.

According to another embodiment of the invention, it is furthermore provided that, in the analysis unit, color matching is performed between the electronic image of the object to be identified and the images of the objects to be identified stored in the database in order to identify the object. An identification of the color of the object to be identified and a corresponding comparison with the objects stored in the database will also increase the rate of identification in a supplemental manner, since the objects to be identified, particularly plugs, may be narrowed down by means of the color. Additionally, color matching represents a particularly simple and reliable identification feature.

According to the invention, the system for identifying an object and for providing information on the identified object comprises a mobile hand-held device and a server unit, which is in principle designed for performing the method according to one or more of the claims 1 through 9.

The system is characterized by its simplicity and compactness, wherein the system offers the user, for example the workshop employee in the workshop, the option of identifying an object to be replaced in a particularly simple and convenient manner and obtaining additional information by means of the display unit on the hand-held device. In a particularly advantageous manner, there is additionally the option of directly executing an order for the object to be replaced using the hand-held device, wherein the mobile hand-held device is then connected via a suitable connection, e.g. an internet connection, to an online shop where the identified object may be conveniently ordered.

For this, the system for identification particularly advantageously has
a mobile hand-held device, which comprises
a camera unit for creating an electronic image of the object to be identified,
a transmitter and receiver unit for wireless data transmission of information to and from a server unit, and
a display unit for a data representation of information.

Additionally, the system particularly advantageously has a server unit, which has
a database with stored images of the objects to be identified, and
an analysis unit for identifying the object in the server unit by comparing the image to be transmitted with the images stored in the database.

The system configured in this way enables the user to identify the object to be replaced using the mobile hand-held device only, for example during workshop operations. This may e.g. be performed directly on the vehicle in the automotive workshop without requiring the object to be removed for this purpose. The mobile hand-held device is characterized by its high flexibility and ease of handling. The data of the object to be identified are transmitted directly from the hand-held device in the form of an electronic image to a server unit, which may, for example, be present locally at the workshop or at a central location, through which the hand-held device communicates, using for example a mobile communications connection or a WLAN connection.

According to another embodiment of the invention, it is furthermore provided that the hand-held device of the system is designed for manual input of information. This embodiment of the invention makes it possible for the user to e.g. add further information to the electronic image, wherein this may be achieved e.g. by means of a standardized query on the display unit in which e.g. a program running on the mobile hand-held device queries information with respect to specific features of the object in addition to the electronic image and transmits it to the analysis unit for comparison.

According to another embodiment of the invention, it is furthermore provided that the mobile hand-held device has means for determining its spatial orientation and/or for detecting its geographical position. A determination of the spatial orientation of the mobile hand-held device, i.e. its orientation with respect to the object to be identified while the electronic image is being created, enables a particularly reliable creation of an electronic image if said device is to be moved with respect to the object to be identified during said creation. The spatial orientation may be determined for example using an integrated gyroscope.

The detection of the geographical position, using for example suitable GPS sensors, makes it possible to determine in which location the electronic image was created. Through a limitation by region, for example a limitation by country, it is then possible to perform e.g. an exclusion of objects within the analysis unit that are not eligible e.g. due to their utilization being limited to certain regions, so that a particularly swift comparison can then be executed.

According to a particularly advantageous embodiment of the invention, it is furthermore provided that the mobile hand-held device is formed by a smartphone. The use of a smartphone is characterized in that said equipment typically already has a display unit and a camera unit, so that the creation of the electronic image can then be performed using a program, an application program (app), running on the mobile device. While the electronic image is being created, frame lines or application instructions may be displayed on e.g. the display unit of the mobile device by the program, the app. The program may furthermore establish a link to an online shop, through which a order of the object to be identified may then be placed directly with the smartphone in a simple manner.

An exemplary embodiment of the invention will be described below, with reference to one drawing. In the drawing:

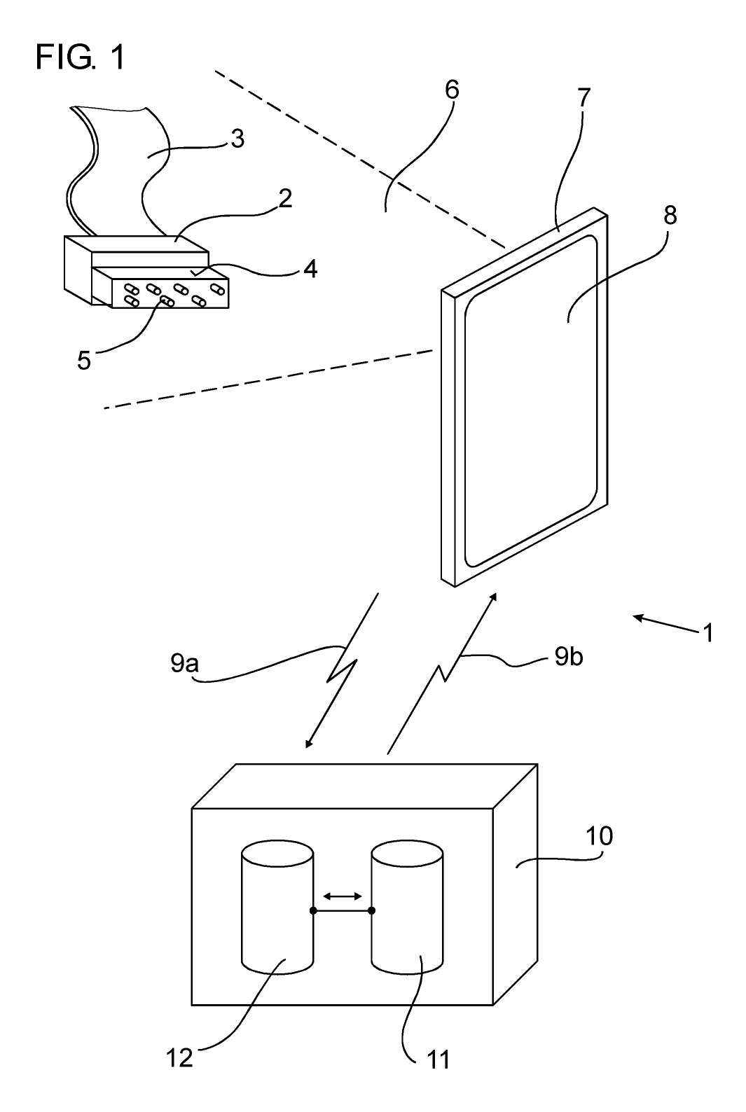

FIG. 1 shows a schematic representation of the system for identifying an object in the form of a plug.

A system, schematically represented in FIG. 1, for identifying an object 2 and providing information on this object 2 has a mobile hand-held device in the form of a smartphone 7 and a server unit 10.

The smartphone 7 makes it possible to create an electronic image of a plug housing 2 positioned in the camera range 6 using a camera unit not shown here. In creating the electronic image of the plug housing 2, the user is supported by means of instructions displayed on a display unit 8 of the smartphone 7, so that the electronic image of the plug housing 2 meets certain general conditions.

In the present exemplary embodiment, the configuration of a coupling portion 4 and the arrangement of the contact pins 5, which are used within the scope of identifying the plug housing 2 within an analysis unit 11 of a server unit 10 in order to perform a reliable identification of the plug housing 2, are thereby also captured during the creation of the electronic image of the plug housing 2.

The electronic image created in the smartphone 7 is transmitted to the server unit 10 via a wireless connection, for example a mobile communications connection, wherein the data transmission 9a, 9b can be performed from the smartphone to the server unit 10 and vice versa. Within the server unit 10, the electronic image is analyzed within the analysis unit 11 and, e.g. within the scope of pattern recognition and taking into account the object characterization, here the arrangement of the contact pins 5 and the configuration of the coupling portion 4, compared with the electronic images of plug housings stored in a database 12. Through the analysis unit 11, the plug matching the electronic image of the plug housing 2 is detected, and information on this plug is transmitted from the server unit 10 back to the smartphone 7, where the user is shown information concerning the plug on the display unit 8.

The creation of the electronic image and the communication with the server unit 10 are achieved for example with an app running on the smartphone 7, which supports the user. The app additionally offers the option of directly ordering the identified object from an online shop integrated in the app.

### REFERENCE LIST

1 System for identifying an object and providing information
2 Plug housing/object
3 Cable
4 Coupling portion
5 Contact pins
6 Camera range
7 Smartphone/mobile hand-held device
8 Display unit
9a/9b Data transmission
10 Server unit
11 Analysis unit
12 Database

1. A method for identifying an object and providing information concerning the identified object on a mobile hand-held device with
a camera unit for creating an electronic image of the object to be identified,
a transmitter and receiver unit for wireless data transmission of information to a server unit, and
a display unit for the data representation of information,
comprising the following method steps of:
creating an electronic image of the object to be identified with the camera unit,
transmitting the electronic image to an analysis unit of the server unit and identifying the object in the server unit by comparing the image transmitted with images of objects to be identified stored in a database,
providing and transmitting information on the identified object stored in the database to the hand-held device, and
representing the information on the display unit.

2. The method according to claim 1, characterized in that the creation of the electronic image is achieved in a manner shown on the display unit.

3. The method according to claim 1, characterized in that, during the creation of the electronic image, the camera unit is shifted, particularly pivoted, with respect to the object to be identified in a manner specified on the display unit.

4. The method according to claim 1, characterized in that, prior to the transmission to the analysis unit or in the analysis unit, the electronic image is electronically processed, particularly adjusted with respect to the brightness and the image size, in such a way that said image will match the images stored in the database, in particular with respect to the image size and brightness of the images stored in the database.

5. The method according to claim 1, characterized in that the shape type and/or at least one object characterization of a characterizing part arranged on the object to be identified is detected using automatic pattern recognition when the image is electronically processed.

6. The method according to claim 1, characterized in that, for identifying objects in the form of plug housings, the contact pins located on the plug housing and/or the shape of a coupling portion of the plug housing form the object characterization.

7. The method according to claim 1, characterized in that the object characterization is formed by an encoding arranged on the object.

8. The method according to claim 1, characterized in that the object to be identified is illuminated with an illumination unit disposed on the hand-held device while the electronic image is being created.

9. The method according to claim 1, characterized in that, in the analysis unit, color matching is performed between the electronic image of the object to be identified and the images of the objects to be identified stored in the database in order to identify the object.

10. A system for identifying an object and for providing information on the identified object with a mobile hand-held device and a server unit, which is designed for performing a method according to claim 1.

11. The system according to claim 10, characterized by
a mobile hand-held device, comprising
a camera unit for creating an electronic image of the object to be identified,
a transmitter and receiver unit for wireless data transmission (9a, 9b) of information to and from a server unit, and
a display unit for the data representation of information,
and
a server unit, comprising
a database with stored images of the objects to be identified, and
an analysis unit for identifying the object in the server unit by comparing the image transmitted with the images stored in the database.

12. The system according to claim 10, characterized in that the mobile hand-held device is designed for manual input of information.

13. The system according to claim 10, characterized in that the mobile hand-held device has means for determining its spatial orientation and/or for detecting the geographical position.

14. The system according to claim 10, characterized in that the mobile hand-held device is formed by a smartphone.

15. The system according to claim 11, characterized in that the mobile hand-held device has means for determining its spatial orientation and/or for detecting the geographical position.

16. The system according to claim 12, characterized in that the mobile hand-held device has means for determining its spatial orientation and/or for detecting the geographical position.

17. The system according to claim 11, characterized in that the mobile hand-held device is formed by a smartphone.

18. The system according to claim 12, characterized in that the mobile hand-held device is formed by a smartphone.

19. The system according to claim 13, characterized in that the mobile hand-held device is formed by a smartphone.
